(19) United States
(12) Patent Application Publication
(10) Pub. No.: US 2010/0218171 A1
(43) Pub. Date: Aug. 26, 2010

(54) COMPUTER BUS MONITORING FOR THE ADAPTIVE CONTROL OF EXECUTING SOFTWARE PROCESSES

(75) Inventors: John C. Munson, Pullman, WA (US); Rick P. Hoover, Boise, ID (US); Jack L. Meador, Boise, ID (US)

Correspondence Address: LAW OFFICES OF RONALD M ANDERSON, 600 108TH AVE, NE, SUITE 507, BELLEVUE, WA, 98004, US

(73) Assignee: Computer Measurement Laboratory, Inc., Boise, ID (US)

(21) Appl. No.: 12/393,962

(22) Filed: Feb. 26, 2009

(51) Int. Cl. G06F 11/36

(52) U.S. Cl. 717/127

(57) ABSTRACT

A computer executing a software process is monitored by a monitor engine that is coupled to one or more buses in the monitored computer and can be installed in the monitored computer or be separate. Software that is to be monitored is certified, i.e., its nominal “normal” operating parameters are determined. Thus, each certified software system running on the monitored computer will have one or more certificates or set points associated with it. An analytical component of the monitoring engine manages the set of certificates for each execution process on the monitored computer. The executing process is monitored by the analytical component and compared against the associated certificate for that process. At any point where the software process begins to diverge from its operational certificate, the analytical component will notify a final control element, or adaptive engine, which can terminate the process or attempt to correct the anomaly.

### BACKGROUND

There are three distinct areas of research related to adaptive control of software processes. The first of these areas is the use of coprocessors in an asymmetric processing configuration. The second is in the area of intrusion detection and autonomic response for system self-protection. Finally, the third is the area of modeling of software behavior or activity.

The majority of the work in the asymmetric coprocessor arena has been devoted to the area of encryption and protection of the execution environment through the use of encryption techniques. The IBM corporation currently manufactures two processors, the 4758 and the 4764 processor, which provide total encryption capability for the zOS and the PC operating environments. In essence, the entire system and its operation is walled-off behind a security facade of encryption. Unfortunately, the activity of the executing code in this environment is not monitored by the security coprocessor. Backdoors and Trojans can still execute with impunity within the system.

Another distinct approach to the notion of a coprocessor that is also in the security arena is one developed by Helbig et al. In this work, the coprocessor is completely interposed between the main central processing unit (CPU) and the rest of the system on the computer. This configuration has the net effect of isolating the principal CPU from the rest of the conventional computer system. All control and data flow pass directly through the interposed security coprocessor.

Another significant approach to coprocessor security in the software systems environment is that suggested by Zambreno et al. In this approach, the development of a hardware coprocessor that will monitor program activity at the register level is proposed. This approach also examines the activity of a program at an extremely fine level of program granularity. It is also dependent on the knowledge of the operation of a specific compiler to model the program register utilization.

Within the domain of the work on autonomic response, it is clear that neither encryption nor obfuscation can prevent the leakage of control flow information. The focus of recent work in this area has been to prevent information leakage from the address bus. Yet another approach specifies a run time infrastructure to provide exploitation resistant communication and coordination services even in the face of distributed attacks. Still another approach contemplates that security attributes must be specified at the beginning of a software development process and then designed into the system.

The problem of maintaining the security of a software process can perhaps best be addressed by understanding that a computer program is, in reality, an abstract machine. The processes that occur within the abstract machine may be measured as the program executes. Through this measurement activity, it should be possible to build a mathematical model of the certified operating characteristics of that abstract machine. Once such a model has been established, it should be possible to monitor the activity of the software machine in a manner very similar to monitoring the activity of a physical hardware system. The various activities of the software machine will generate measurable characteristics. These characteristics can, in turn, be monitored while the software is performing known and certifiable activity. The data generated from this process might then be used as a basis for forming a mathematical description of the state space of normal or nominal program activity.

The activity of an executing software system is visible in the various subsystems of a computer. The CPU, for example, is dependent entirely on the software that is executing on that system. This means that the operation of a software abstract machine is made manifest in the physical world in the operation of the CPU, the bus traffic to and from the CPU and the contents of memory at various points in the execution of the software.

In addition to monitoring the execution of a software system in real time, it should also be possible to control the execution of the software. That is, the software system might be altered at run time in response to a detected abnormal condition. Perhaps the simplest example of the alteration of software at run time is represented in the abnormal termination of software by a monitoring/control system. The notion of imposing external control on an executing software system based on data derived from the operation of the software is thus a natural extension of the concept of process control. It should be possible to greatly extend this simple concept to provide substantial benefits in controlling the execution of a software program in response to conditions detected by monitoring the process being executed.

### SUMMARY

Accordingly, an exemplary novel approach has been developed to implement the dynamic monitoring and control of software processes. This approach represents a mechanism for the dynamic measurement of executing software systems, a mechanism for using the resulting measurement data to determine whether a software process is executing within a pre-established nominal framework, and a mechanism for modifying the execution of a software system if it is executing outside a certified execution framework. As used herein and in the claims that follow, it will be understood that the term “software process” is intended to be generally synonymous in its singular and plural forms respectively, with the term “software program.”

The activity of a software process can be monitored by an adjunct hardware system that tracks the effects of software execution on a principle CPU. This technique can be implemented by attaching a hardware decoder to one or more buses in the CPU. The hardware decoder can monitor these buses and send measurement telemetry based on the monitored data to an analytical system that determines whether the software is executing within an acceptable or certified range. This strategy is pure in that the monitoring and analysis function is implemented using additional hardware that performs the measurement and analytical functionality.

There is also an exemplary hybrid design embodiment, wherein the executable code as generated by a compiler includes observable events, such as a write to a specific memory location that may be detected by assisting hardware. In this case, the assisting hardware is watching for specific events, such as writes to specific memory locations, although it will be understood that in this novel approach, the assisting hardware can function to detect other types of defined events and is not limited to detecting a system writing to one or more specific memory locations.

Given the intrusive nature of a software monitoring process, it is clearly preferable to employ an unobtrusive approach for the measurement of executing software. In an exemplary methodology, the monitoring function is a separate monitoring environment that is implemented by a separate controller or analysis system. The basic structure of such a system being monitored includes a “monitored computer,” and a system that is performing the monitoring function, i.e., a “monitor engine.” On the monitored computer side, there are two distinct software systems that are being monitored, including the operating system executed by the system, and the set of application software (i.e., one or more software programs) that will run under the aegis of the operating system. On the monitor engine side, there is a single software system that can serve to implement the controller function, and that software system is referred to herein as an “analytical engine.” (or AE).

The general model of software process monitoring in accord with the present approach is shown in FIG. 4 and is discussed in more detail below. In this model, telemetry from the executing software process is sent to a monitoring function, i.e., to the analytical engine. The state of the executing software process is compared against a model of nominal activity known as the certificate. If the software is found to be operating in an off-nominal (i.e., an abnormal) condition, the analytical engine reports this condition to the adaptive engine. Based on a policy established by the policy engine, the adaptive engine then alters the execution of the software process. Policy for the adaptive engine is established by the interaction of the software administrator with the policy engine.

Software that is to be monitored is certified. Each certified software process has one or more certificates associated with it. A certificate is a compact representation of expected state evolution. The analytical engine manages the set of certificates for each process to be executed and uses the information encoded by an associated certificate to characterize the validity of current program state as it executes. The current program state is deduced from telemetry data obtained during program execution. If the difference between the current program state and a state that is predicted by the certificate for the process increases above a pre-established threshold, the analytical engine notifies an adaptive engine that corrective action may need to be taken. The action taken by the adaptive engine is determined beforehand within the policy engine. The policy engine is under direct control of the system security administrator. Corrective actions that may be taken include, but are not limited to: program termination, priority reduction, and dynamic modification. In all cases, any corrective action taken is reported via the security administration interface of the policy engine as soon as it occurs.

The analytical engine, policy engine, and certificate store reside in an independent hardware-based system that cannot be influenced by the monitored system in any way that is not directly related to system reliability or security. The adaptive engine is implemented within a protected part of the monitored operating system in a way that safely enables any of a number of possible corrective actions to be taken.

The certificate associated with control of a process is a compact representation of expected process state evolution. Certificate data include, but are not limited to, probabilities of expected state sequences. In one exemplary embodiment, state sequences are encoded as words arising from an abstract alphabet representing function calls and returns. In this case, the telemetry data are obtained by instrumenting the software with brief instruction sequences that report calls and returns to the analytical engine interface. In another exemplary embodiment, telemetry data are obtained directly from the monitored processor hardware without affecting the monitored software process. Here the state evolution alphabet contains address values read from the processor instruction pointer when key control flow instructions are executed. In this case, the certificate is encoded in a fashion that facilitates proper address translation when any form of code relocation is employed by the monitored software system.

The foundation of the methodology is to utilize non-intrusive measurement methodology as the basis for monitoring, analyzing, and adapting the activity of monitored software system. It is possible to monitor, exclusively in software, the operation of the system, in order to determine if it is behaving normally. However, such monitoring imposes considerable overhead, both in time and space—this overhead is precisely a part of the system that designers would wish to eliminate in a final implementation of the software system, to reduce costs. Even if the monitoring overhead is retained in the final system, its very presence confounds its own ability to monitor the system, by adding complexity, and possibly introducing unwanted behaviors, such as additional interrupts, longer system call executions, undetectable vulnerabilities, etc.

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 is a block diagram illustrating an exemplary system that implements the present novel approach and includes a monitored computer that executes a software program, and a monitoring computer that monitors the execution of software processes on the monitored computer;

FIG. 2 is a simple block diagram showing the connection of a decoder to the CPU bus of the monitored computer to enable an analytical engine to monitor software processes;

FIG. 3 is a block diagram of an exemplary embodiment in which a CISC program space is coupled to a CISC to RISC translator to enable a decoder to couple to a separate RISC machine;

FIG. 4 is a functional block diagram illustrating the relationship of the certificate provided for a software process and the various engines involved in monitoring the software process;

FIG. 5 is a flow chart showing exemplary steps for implementing the present novel approach for monitoring software processes;

FIG. 6 is a more detailed block diagram of an exemplary system that is configured to implement the present novel approach;

FIG. 7 illustrates an exemplary mapping from a set of operations to a set of program modules, illustrating how a specific operation is related to one or more program modules in a software program;

FIG. 8 is a schematic diagram of a program call tree that is defined as a function of the program design process, and this example corresponds to the mapping shown in FIG. 7; and

FIG. 9 is a schematic diagram of the architecture for an exemplary hybrid strategy, in which a single or multiple lane PCI Express (PCIe) board is employed to implement the monitoring functionality of a personal computer in which the PCIe board is installed, in accord with the present novel approach.

### DESCRIPTION

### Figures and Disclosed Embodiments are not Limiting

Exemplary embodiments are illustrated in referenced Figures of the drawings. It is intended that the embodiments and Figures disclosed herein are to be considered illustrative rather than restrictive. No limitation on the scope of the technology and of the claims that follow is to be imputed to the examples shown in the drawings and discussed herein.

### Overview

Central to the present novel approach is the concept that control flow, both within and between program modules of a software system, is important for understanding the execution of a software system. Basically, this control flow is made visible at the CPU level through software updates to an Instruction Pointer (IP) register during an instruction execution phase in the CPU. This IP register may be altered by a number of distinct program activities. For example, it may be directly updated by a jump, branch, or test instruction. Its contents may be saved and updated in a call-return sequence. Finally, the IP register may be altered by an external event represented by an interrupt.

In the normal flow of program control, the IP register is automatically updated during a fetch cycle. The above program activities will further update the IP register during the execute cycle. It is also important in the present approach that a special purpose decoder be introduced into the architecture of a system that will capture these changes to the IP register.

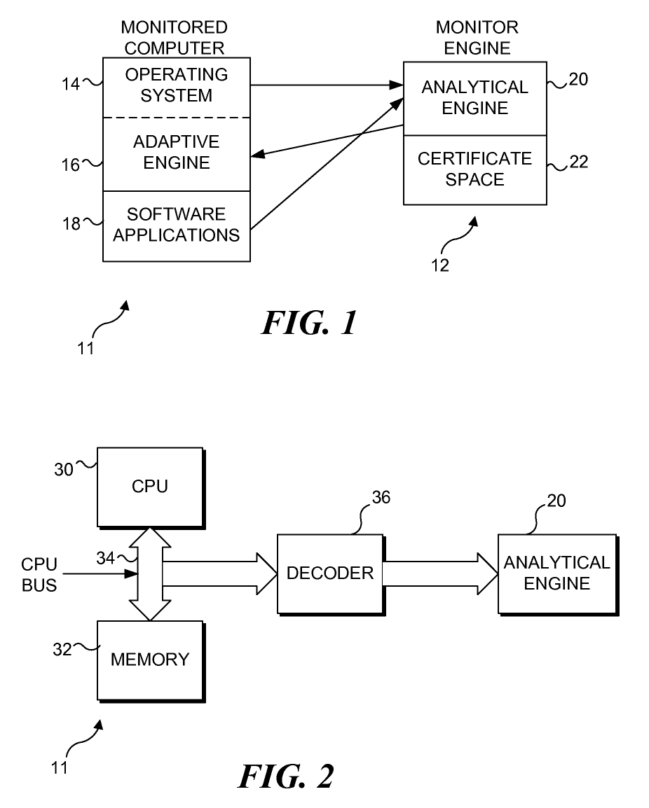

FIG. 1 illustrates a monitored computer 11 that is coupled to a monitor engine 12. The monitored computer is running an operating system 14, such as a version of Microsoft Corporation's WINDOWS operating systems, or some form of UNIX or LINUX operating system, or an Apple Corp. operating system. An adaptive engine 16 is also executed on the monitored computer, and details of its function are discussed below. Processes such as those included in one or more software applications 18 or in operating system 14 are monitored by monitor engine 12 to detect if any certified process being executed is deviating from its expected or normal behavior. The monitor engine implements an analytical engine 20 that interacts with the operating system and the adaptive engine to determine if the functions implemented by each monitored process are operating within the certified normal limits for the process. The certified normal limits are defined by an associated certificate that resides in a certificate space 22.

### CPU Instruction Execution Monitoring

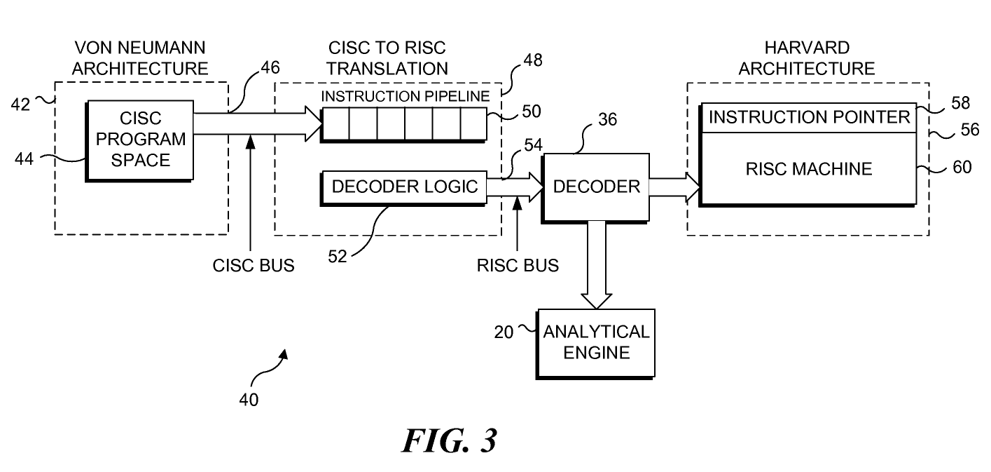

In this exemplary embodiment of non-intrusive software measurement and monitoring, program control flow is directly monitored within a central processing unit (CPU) of a computer system, virtually independent of program execution. For example, FIG. 3 shows a typical core of many modem CPU architectures where a Reduced Instruction Set Computer (RISC) 60 interprets sequences of very wide instructions to effect the execution of a Complex Instruction Set Computer (CISC) program. A CISC-to-RISC instruction translation 48 is implemented via an instruction pipeline 50 with a decoder logic 52 that relates CISC instruction sequences to internal RISC control sequences on a RISC bus 54. The central hardware feature of RISC 60 that maintains program control flow state is an Instruction Pointer (IP) register 58. In this embodiment, an analytical decoder 36 monitors the internal RISC control sequences for IP-altering events such as branches and test instructions, as well as IP-capturing events such as call instructions and interrupt activities. When analytical decoder 36 detects any such events, it signals analytical engine 20 with the nature of the event and the specific value contained by the IP. One advantage of this approach is that the analytical engine may take action immediately upon encountering an instruction-address pair that requires a correction. Another is that little or no additional overhead is imposed upon nominal software operation, since the analytical decoder and analytical engine hardware operate in parallel with the hardware that controls program execution.

The user's software is compiled to run within a CISC program space 44, which is organized in a fashion consistent with a von Neumann computer architecture 42. However, the software execution is governed by activities within the RISC that is organized more like a Harvard Architecture 56, where instructions and data reside in separate spaces. An ability to locate instructions and data anywhere in a shared program space is an attribute commonly associated with the von Neumann organization. The RISC has very little or no control over the memory address translations required to implement the instruction and data relocation implied by the von Neumann architecture. As a result, to accurately characterize program control flow using CPU instruction execution monitoring, it is necessary to also account for instruction address relocation in CISC program space 44. One way to achieve this requirement is to locate a portion of the analytical engine within the hardware that controls memory address translations. Another is to modify program certificates and/or their interpretation by the analytical engine.

A program's certificate encodes the statistical probabilities of its state evolution. In this example, program control flow is used to characterize state evolution. Here, the control flow is encoded as instructions and addresses—i.e., instructions that either change or refer to addresses in CISC program space 42. Since the von Neumann architecture allows instruction and data addresses to vary with time, it is necessary to account for this variation somewhere in the control flow analysis process performed by analytical engine 20. This function is accomplished either dynamically during program execution, or statically, when instruction blocks are loaded into memory. In a dynamic approach, a portion of analytical engine 20 resides in the memory management hardware where it continuously monitors IP 58 address translations to CISC program space addresses 42. In the exemplary embodiment of FIG. 3, it is assumed that instruction address relocation is accounted for statically. This exemplary embodiment assumes that the absolute instruction addresses of CISC program space 44, as determined by the operating system program loader, are made available to analytical engine 20 when the program is loaded into memory. In this case, a program certificate encodes program addresses as offsets relative to one or more base addresses. It is the program base addresses that are reported to analytical engine 20 by the operating system whenever the program is loaded into memory. This reporting activity imposes a very small amount of additional overhead to program loading, but has very little or no effect upon program execution times.

Variations of instruction execution monitoring are also possible for other CPU organizations. For example, monitoring of pure RISC and Very-Long-Instruction-Word (VLIW) computer architectures would proceed in a fashion similar to that detailed in FIG. 3, with the exception that CISC to RISC translation 48 reduces to an instruction pipeline with simpler decoder logic 52.

### CPU Bus Monitoring

CPU bus monitoring obtains program control flow information from outside the CPU via any of its associated bus interfaces. As shown in the simplified architecture illustrated in FIG. 2, in a non-pipelined computer 11 with no instruction caching, analytical decoder 36 serves the simple role of a bus monitor. The decoder monitors a CPU bus 34 coupling a CPU 30 with a memory 32 to detect instructions and activities that will cause the IP register to change outside of the normal fetch activity of a program. The contents of the updated IP register address and the activity that caused the IP register to be changed are then sent from analytical decoder 36 to analytical engine 20. The architecture shown in FIG. 2 is commonly found on embedded computer systems, but without the functionality of analytical engine 20.

In a variation of the architecture shown in FIG. 2 that includes instruction pipelining and/or caching, the functionality of analytical decoder 36 becomes more complex. Here, the analytical decoder must also act as a predictor of CPU 30 instruction cache and/or pipeline state. The prediction of these states plays an important role in determining program control flow, but are otherwise largely hidden from CPU bus 34 signals. In this case, the hardware used for analytical decoder 36 includes a model of the CPU, cache, and pipeline that either replicates, or at least approximates the CPU control flow, to the extent required for the level of accuracy needed. That information, combined with the observable bus data, is then used by analytical engine 20 to measure the current state of the overall system.

### Peripheral Assisted Monitoring

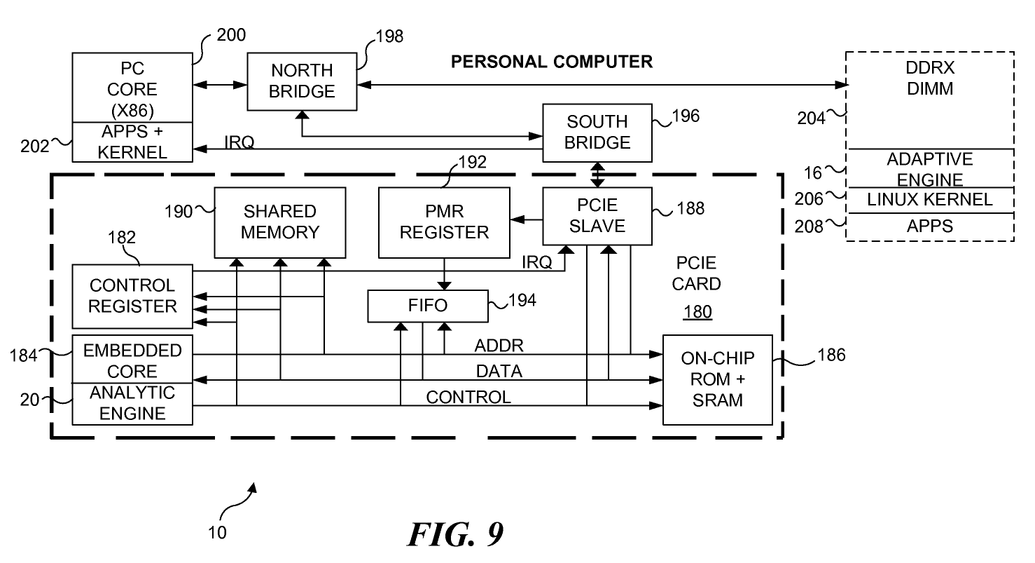

Peripheral assisted monitoring employs peripheral hardware to assist with the software monitoring task. For example, a monitoring system that is interfacing via the Peripheral Component Interconnect (PCI) or PCI express (PCIe) bus is shown in FIG. 9. In this approach, a single or multiple lane PCIe board 180 in computer 11 is employed to implement the monitoring functionality. The PCIe card or board includes a control register 182 that is coupled via address and data lines to an embedded core 184, an on-chip read only memory (ROM) and static random access memory (SRAM) 186, a PCIe slave module 188, a shared memory 190, and a first-in-first-out (FIFO) buffer 194. Control register 182 also produces an interrupt (IRQ) signal that is provided to PCIe slave module 188. A process monitor register (PMR) 192 is also coupled to FIFO 194. For this exemplary PCIe implementation, the resulting board can plug into a compatible PCIe slot located on the motherboard in computer 11 and will connect to south bridge 196, which is connected to north bridge 198. An interrupt (IRQ) signal is produced by south bridge 196 and is coupled to applications and kernel 202 running on a PC core 200 in this X86 type computer. The north bridge is also coupled to a double data ram (DDRX) dual in-line memory module (DIMM) 204 in the monitoring engine, which includes adaptive engine 16, and a Linux kernel 206 (in this embodiment), and which runs other applications 208.

Peripheral assisted monitoring is a hybrid approach that requires monitored software to be modified to co-operate with the monitoring peripheral. Here, the software systems to be monitored are modified so that the call and return instructions are logged as events in the assisting hardware. To achieve this function, a modified compiler is used to instrument the code with writes to a specific memory location that will be used for process monitoring. PMR 192 can then be accessed by analytical engine 20 for each corresponding call and return instruction. Typically, the additional code that must be added for each call and return is approximately equivalent to two assembly-level instructions on an Intel Corp. Pentium™ class processor. The first instruction writes to a register with the data to be written to the PMR, and the second instruction writes that data to the PMR.

At the point where a monitored process crosses the threshold of nominal operation, the analytical engine on the PCIe board generates an interrupt to transfer control from the executing process to the Linux kernel. This interrupt is trapped by the interrupt service routine, which in turn, passes control on to adaptive engine 16, so that the adaptive engine can manage the anomaly in the executing software.

### The Execution Certificate

An execution certificate for a program establishes the set point for the software process controller. It captures the statistical probabilities associated with certified program state evolution. At the point that any certified software process is executed, its execution certificate will be acquired by the process controller.

The precise structure of the execution certificate is a function of the measurement domains that are chosen to be monitored. The execution certificate is, at its core, a mathematical description of the certified activity of a program that is to be monitored. The execution certificate will typically reside in a secure and protected domain of the analytical engine. As each process is initiated by the operating system, the certificate associated with the process will be retrieved by the analytical engine. The activity of the monitored process is then followed by the analytical engine, as it analyzes the data arriving from the executing process.

If, for example, the executing process is to be monitored for all “between module” activity, the execution certificate would consist of a n-ary call tree that was constructed from the software calibration process. This n-ary tree would, in fact, comprise a subset of all possible arcs in the potential call tree of the program, i.e., just those that were observed when the program activity was being certified. Each of the possible paths in this n-ary tree would be represented by a word in the execution vocabulary of the program. Thus, the certificate would also contain a list of these words, together with the probability of their being encountered as the program is executing.

All certified software systems must have a stored execution certificate. This certificate may actually accompany the software system in an encrypted form in the software load module. Alternatively, the certificate may reside in read-only memory within the analytical engine. In an operational certified system in accord with this novel approach, no software will be enabled to execute without a valid execution certificate.

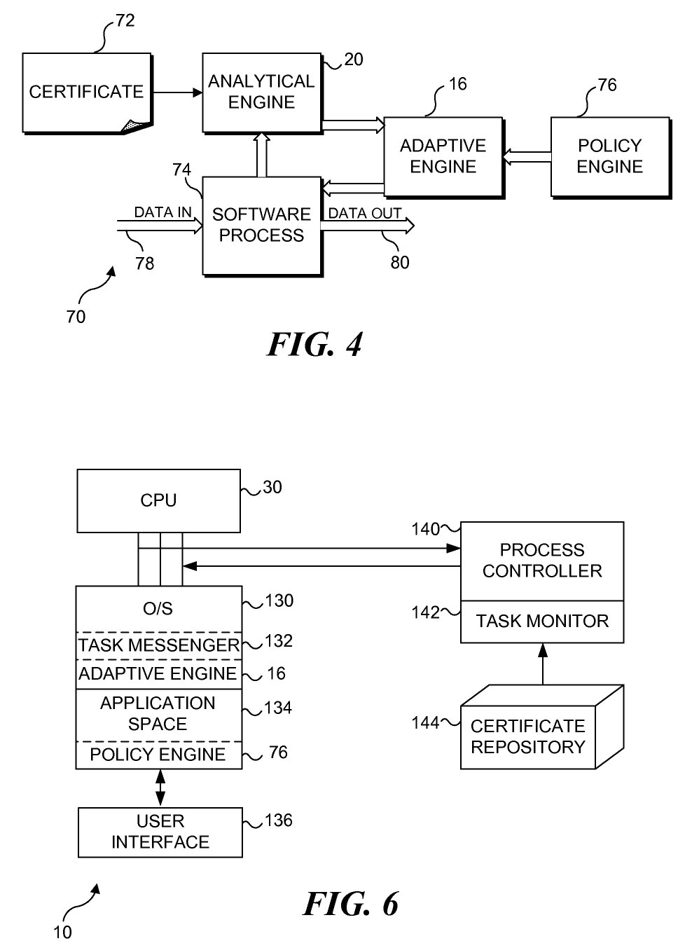

FIG. 4 illustrates a block diagram 70 showing how a certificate 72 for a software process 74 is supplied to analytical engine 20. Software process 74 will typically be processing a stream 78 of input data and producing a stream of output data 80 on which the process has been applied. The input data stream will modify the activity of the software process. This induced activity will be monitored by the analytical engine, which compares the current state of the activity in the software process with the reference model (certificate) of nominal activity. At the point that the software process begins to exceed a threshold, the activity of the software process may be altered. The analytical engine interacts with adaptive engine 16, and the adaptive engine may alter the execution framework of the software process. The manner in which the process is controlled relative to the certificate is determined by inputs from a policy engine 76, which is the user interface to the system.

### The Architecture

The underlying system architecture has two significant components. The analytical engine measures the continuing operation of the software system for nominal activity. When the system is diagnosed to be in an abnormal state, the analytical engine captures control and hands it to the adaptive engine to ameliorate, terminate, or correct the activity that drove the system to its abnormal state.

There are two distinct phases of operation for the analytical engine. The first mode of operation is the calibration phase. During this mode of operation, the system will be exercised in its normal mode of operation. The analytical engine will then build the model of normal system activity from the repertoire of functions that occur during this observation interval. When the system has been appropriately calibrated, it is then ready to be placed in its operational mode. In essence, then, there is a learning phase for a software process that precedes an operational phase in the use of the analytical engine to monitor that process. A fundamental concept is that there is no standard model of software activity. The normal activity of a system is entirely dependent on the role that the software system will be asked to play. When the same software system is deployed in a number of different operational contexts, the label of “normal” is defined by the specific context in which the software system is used. The obverse of this coin is that abnormal system activity is also context dependent. The same assault on a system will be expressed differently in system activity depending on the operations being performed on that system. A key concept to the success of this monitoring strategy is that it is adaptive and will function equally well in a host of different contexts.

The precise nature of the adaptive engine is dependent on the role that the monitor system is serving. If the issue at hand is one of reliability, safety, or survivability, the adaptive engine can be empowered to modify the flow of execution of the software application, thus removing the offending functionality. If, on the other hand, the criterion is a performance related issue, then the abnormal activity is indicative of the sub-optimal configuration of the hardware. In this context the adaptive engine may be empowered to alter the configuration of the principal CPU to reflect the change in the operating environment.

The adaptive engine also establishes the necessary tools to support the execution environment of safety critical applications. Perhaps the greatest threat to the reliable operation of a modem software system is the unanticipated demands placed on the system by the environment. As a consequence, the system may well shift from a reliable execution framework, to an uncertified/unreliable one.

### The Analytical Engine

As a program executes a particular user operation, it transfers control from one module to another. There is always a main program module that receives control as the program begins to execute. The structure of the executing program may be represented as a call tree, where the root of the call tree represents the main program module. Each program functionality is represented by one or more sub-trees of this call tree, depending on the number of operations that are implemented by that functionality.

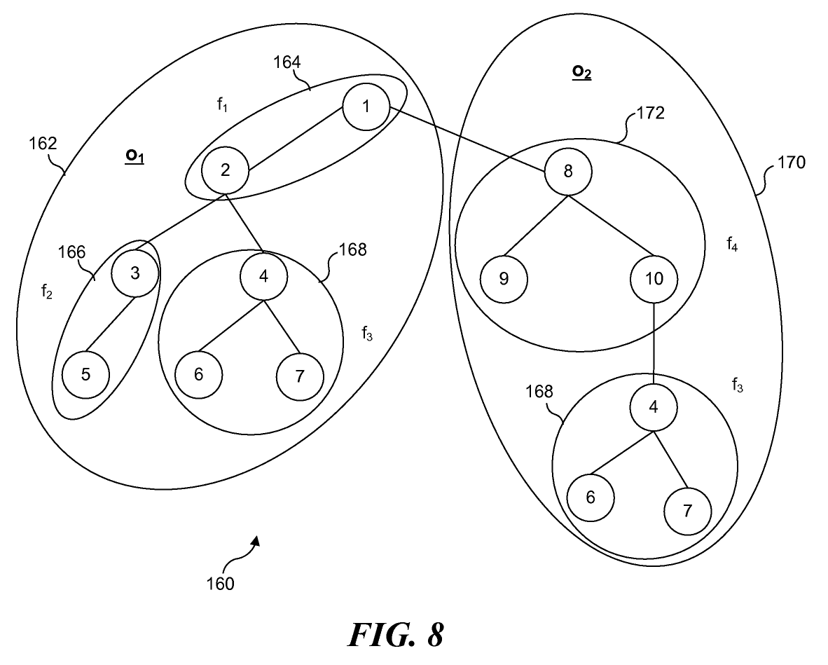

FIG. 8 shows a hypothetical call tree of a program whose main module is represented by the root node. All other nodes of the call tree represent program modules. Each arc of the tree represents a relation such that a specific instance of a parent module will instantiate a copy of a child module under some potential condition of program execution. Program modules are structured in terms of calls among the program modules into call trees. Functionalities are expressed as sub-trees of call trees. There is a distinct feasible call sub-tree for each functionality. A functionality sub-tree is constructed from a call sub-tree by substitution. A functionality node replaces each call sub-tree representing that functionality in the original call tree. The end result of this substitution is the construction of a functionality sub-tree displaying the interrelationship of the set of possible functionalities. This reduction may be carried yet one further step. Since each operation comprises functionalities that are organized into functionality sub-trees, substituting an operational node for the functionality sub-trees that comprise that node can reduce the functionality tree by a further step. In this final step, the operational tree is created, revealing the operational structure of the program.

Just as each node of the call tree provides an abstraction of the processor instructions executed when a module is instantiated, a sub-tree represents an abstraction of a function that is performed when its root module is instantiated. In FIG. 8, a sub-tree 168, for example, represents a function f3 that is performed when a module 4 is instantiated within the context of a module 2. Sub-tree 168 shows that function f3 is also performed when instantiated within the context of a module 10. Similarly, more abstract operations are represented as sub-trees of functions. Operation O2 (reference numeral 170), for example, represents the function sub-tree comprising functions f4 (reference numeral 172), and f3 (reference numeral 168).

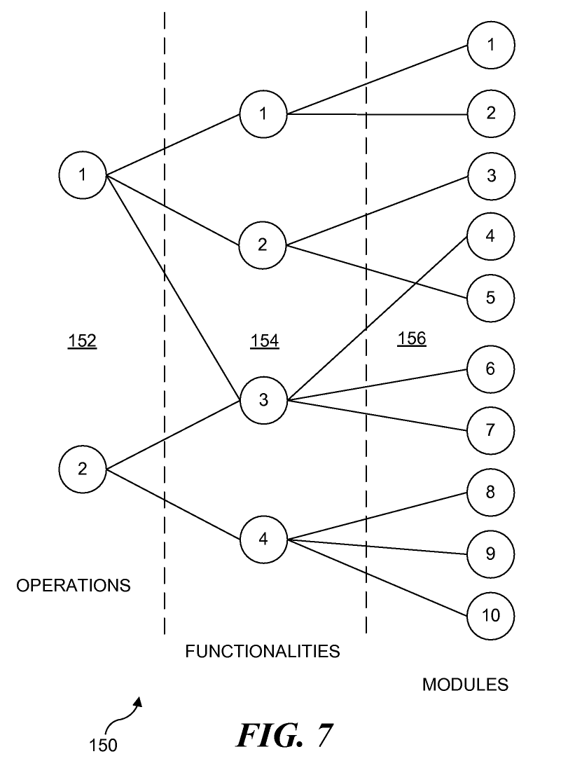

FIG. 7 underscores the importance of the organizational relationship between executable modules 156 of a hypothetical program call tree and its abstract functionalities 154, and operations 152. Just as the modules are executable and shareable partitions of functionalities, the functionalities are the potentially shareable partitions of operational specifications. In particular, operations specify what is to be done while functions represent how operations are implemented.

The key contribution of the monitoring architecture is the characterization of the reliability of a software system in terms of the system's certified activities as it executes its various operations and its implication on system survivability. The certified assessment of the program activity is accomplished dynamically while the program is executing, to identify changes in software activity directly attributable to a failure event or the execution of an unprecedented operation (e.g., an attack). It is understood that no software system can be thoroughly or exhaustively tested for all possible contingencies. However, it is possible to certify a range of software behaviors that represent the certified program activity of a correct design specified software system, for a defined context.

By incorporating the monitoring function directly into the system design methodology, it is possible to drastically shift away from the current paradigm that addresses reliability, security, and survivability in an add-on fashion, occurring at the end of the design cycle. Instead, a unified and integrated design methodology for monitored systems is outlined below. The essence of the new architecture is that it will provide the ability to reliably monitor an executing software system in real time. It will also provide the infrastructure to modify the executing process should anomalies in the activity of this system occur while it is executing.

The second aspect of the operation of the analytical engine is the nominal operational phase. This is the normal mode of execution monitoring for the analytical engine. During this phase of execution, each new execution word will be validated against the nominal distribution of the words in the execution alphabet. There are two aspects of this validation process. As each new word is formed on the call stack, the word must be part of the execution vocabulary. Second, if the probability of encountering a given word is very low, then the word must not occur with a high probability in future contexts.

In addition to the real time monitoring of process activity, the analytical engine must have the capability of managing abnormal software execution scenarios that occur in a very few instruction cycles. Again, the most pertinent example of such an attack is a buffer overflow. One of the possible symptoms of such an attack is that the program will attempt to fetch an instruction that is in the program data (D) space. In that case, there must be logic in the analytical engine to store instruction (I) and D space boundaries and to insure that all program fetches occur in the program I space.

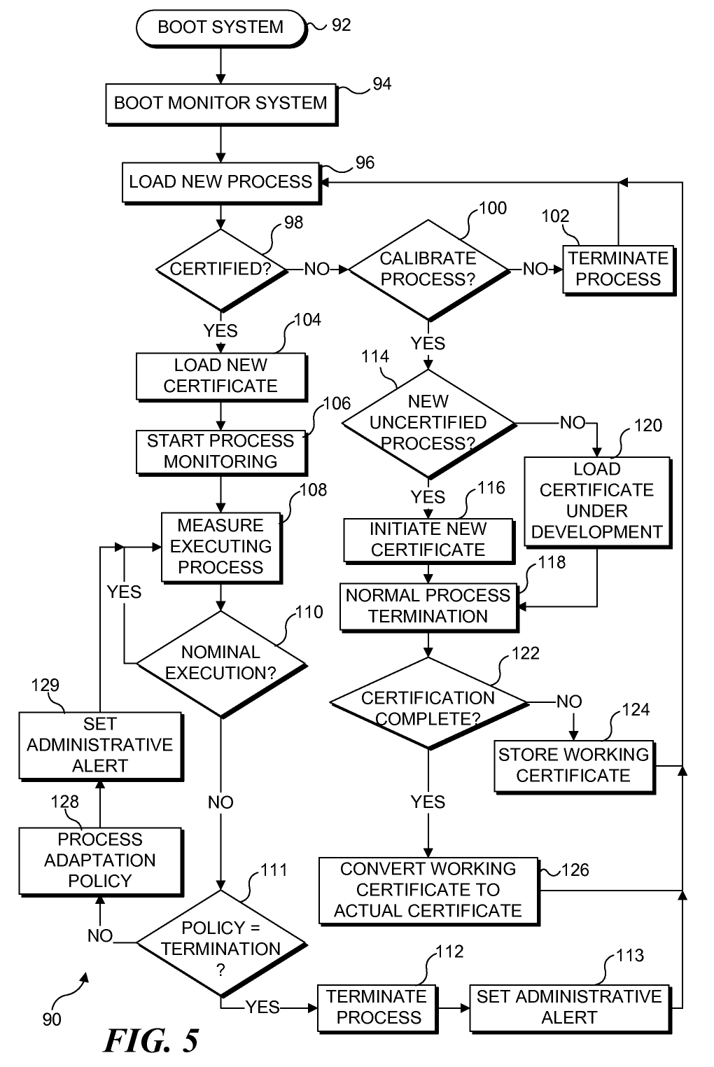

Exemplary logical steps for implementing the present approach are shown in a flowchart 90 in FIG. 5. As the system is booted (started up) in a step 92, a boot monitoring step 94 is invoked. A step 96 loads a new process to be executed by the monitored system. A decision step 98 then determines if the new process has been certified. If not, a decision step 100 determines if the new process is to be calibrated. If not, a step 102 terminates the process, since without calibrating a process, the monitoring system will not be able to determine when the process is functioning in an abnormal state. The logic then returns to step 94.

However, if the process is already certified in decision step 98, a step 104 loads a new certificate that is associated with the new process. Next, a step 106 provides for the monitoring engine to start monitoring the new process, e.g., by measuring the executing process in a step 108. A decision step 110 determines if the process execution is nominal. If so, the step of measuring the process continues in step 108 (note—although not shown, once the process is complete, the logic returns to step 96 to load a new process for execution). If the process execution is not within the nominal range, a decision step 111 determines if the policy requires termination of the of process (as being abnormal), and if so, a step 112 terminates the process. Next, a step 113 set an administrative alert to indicate that the previous process was terminated. The logic then returns to step 96, to load a new process.

Referring to decision step 100, if the new process just loaded is to be calibrated, a decision step 114 determines if the new process is a new uncertified process for which calibration has not yet been started. If so, a step 116 provides for initiating a new certificate. The new process is then permitted to continue until it reaches normal termination in a step 118. A decision step 122 then determines if the certification is complete. If not, a step 124 stores a working certificate for the process, and the logic returns to step 96. Conversely, if the certification is complete, a step 126 converts the working certificate to an actual certificate before also returning to step 96.

If decision step 114 determines that the process is not a new uncertified process, but instead, that the certification is being developed, a step 120 loads the certificate that is under development for the process. The logic then again proceeds to step 118 to enable the process to reach a normal termination.

In decision step 111 determines that the policy does not require termination of the process due to an abnormal execution, a step 128 implements a process adaptation as defined by the policy. Next, a step 129 sets an administrative alert to indicate that the process has been adapted in an attempt to correct the anomaly in the execution of the process. The logic then continues with step 108, to determine if the adaptation was successful.

Once the logic in flowchart 90 is complete, each process running on the monitored computer should have been provided with a corresponding certificate.

### Task Management

A task is, by definition, the smallest unit of a software process that can be scheduled by an operating system and is typically a main program or a thread of a main program. In a single processor system, each task is typically assigned a process identification (PID) when the task is initiated. Tasks may be active, actually executing on the CPU, or tasks may simply be ready, which means that they are awaiting execution in a process queue. Tasks may also be inactive, if they are awaiting the arrival of services to be delivered by the operating system. In a multiprocessing system, there will be two or more CPUs, and the operating system must then bind each task to a particular CPU.

In regard to the concept of a task, a block diagram of a more augmented view of an exemplary embodiment of a software process control system in a monitored computer 11 is illustrated in FIG. 6. The actual selection of a task for execution on a particular CPU is a function of the task dispatcher within the CPU. There may be many different tasks that execute sequentially on a system as applications in an execution space 134 are executed, in accord with policy engine 76. Therefore, monitoring the CPU bus without knowledge of the executing task provides little usable information about each of the possible tasks that may be executing. To this end, an operating system 130 should be augmented with a Task Messenger 132, which captures the pertinent information about the currently executing tasks. This information can then be passed to a Process Controller 140 within the analytical engine, for use by a task monitor 142. The task monitor receives certificates corresponding to the currently executed process from a certificate repository 144. A user interface 136 is provided to enable a user to interact with, provide input to, and control processes running on CPU 30 within computer 11.

### The Task Messenger

The real function of the task messenger is to monitor the task switching function in the operating system. The task messenger is a software process embedded in the operating system to track the assignment of software processes to CPUs. Each process is in turn, identified by its PID and its name. The task messenger builds a vector <PID, Process-Name, CPU#>, at each context switch in the operating system.

### The Task Monitor

The process controller, or analytical engine, can only monitor one process at a time. The function of binding executing processes to the set points or certificates that represent their nominal activity is the function of the task monitor. As each new vector representing a task switch is generated by the task messenger, task monitor 142 can use this vector to bind the process controller to the certificate representing that task.

### The Adaptive Engine

The adaptive engine component of the system can reside in the memory of the monitored computer, for example, as an attachment to the operating system environment. This component will be invoked at the discretion of the analytical engine through the system interrupt structure, and the adaptive engine can alternatively be invoked by the process controller. In the last analysis, the adaptive engine will likely be the mechanism that captures control when an abnormal condition arises within the process controller.

In the advent that an abnormal activity is observed by the process controller, data indicating the nature of the abnormality can be transmitted by the process controller to the adaptive engine. The response of the adaptive engine to the departure from certified behavior can be determined, a priori, by an operational policy set by the system administrator. The simplest possible response by the adaptive engine to a noted departure from normal process execution would be to instruct the operating system to terminate the aberrant process.

Each abnormal condition is carefully articulated in the operational policy. For each abnormal condition, the system can take appropriate action as dictated by the underlying policy. Thus, a key component in an effective embodiment of the adaptive engine will be the design of the protocol for the policy that will in turn, govern the operation of the adaptive engine.

### The Policy Engine

There are two issues related to the operational policy for the system. The first policy component specifies when to take action, and the second component specifies the action that is to be taken. The analytical engine, for example, may be instructed to take action when a new word is observed on the execution call stack. The associated action would likely be to generate an interrupt of the system bus so that the adaptive engine can acquire control of the system. On the other side, the adaptive engine would receive control as a result of this interrupt. It can then implement a predefined policy action associated with the recovery from the unexpected program activity.

The precise set of immediate response policy requirements should be carefully articulated during the initial design stages. Also these immediate response policies should be part of the system policy architecture.

A system administrator can establish policy. A very important role for the policy engine is to interface with the system administrator through a user interface, such as user interface 136 in FIG. 6. Through such interaction, the system administrator can specify criteria that should be applied for each type or each specific aberrant behavior detected during software process execution.

### The Measurement Attribute Domains

It is possible to measure quite a large number of program attributes at the level of the computer that is actually executing a program. One objective is to discover a minimal set of such measures that will provide the resolution necessary to determine whether an active software process is performing in a normal/certified manner.

In the simplest form, the operation of a software process might be described by a single measure or variable. In such a model, a decision might be made, for example, to measure the number of procedure calls during a fixed time interval. Such a single variable measurement system would be denoted as a univariate process control system. Alternatively, the measurement space may include multiple distinct variables that will be measured simultaneously. A process control system based on multiple measures would be known as a multivariate process control system.

One of the single most important aspects of the concept of software measurement is that it is possible to construct a mathematical description or model of normal behavior. The foundation of this model is derived from work in dynamic software measurement. To lay the foundation for a measurement-based, dynamic monitoring system that permits the real time assessment of software reliability, it is necessary to establish a conceptual foundation for program execution that lends itself to a suitable instrumentation for the monitoring and failure analysis processes.

A software system in operation will distribute its activity across a set of distinct operations. Thus, it is possible to define more precisely the notion of the activity of the system in regards to the executing software system.

To lay the foundation for a measurement based, dynamic monitoring system that permits the real time assessment of software reliability, it is necessary to establish a model for program execution that lends itself to a suitable instrumentation for the monitoring and failure analysis processes. In the subsequent discussion of program operation, it is useful to make the description of program specification, design and implementation somewhat more precise by introducing several notational conveniences. This discussion can begin by observing the fact that there are really two distinct abstract machines or models that define the implementation in the development of any software system.

### Operational and Functional Machine

The first abstract machine is an operational machine, which is a machine that interfaces directly with a hardware interface. The embedded system provides a suite of services to the hardware system. Each of these services cause the operational machine to perform a series of actions called operations. Each of these operations, in turn, causes the operational machine to perform some specific action. It is the purpose of this operational machine to articulate exactly what the software system must do to provide the necessary services dictated by the embedded software system requirements.

The second abstract machine is a functional machine, which is animated by a set of functionalities that describes exactly how each system operation is implemented. Whereas the operational abstract machine articulates what the software system will look like to the hardware system in which it is embedded, the functional abstract machine is the entity that is actually created by the software design process. Turning now to the precise relationship between the operational abstract machine and the functional abstract machine, it is quite conceivable that a system could be constructed wherein there is a one-to-one mapping between a user's operational model and the functional model. That is, for each user operation, there might be exactly one corresponding functionality. In most cases, however, there may be several discrete functionalities that must be executed to express the system services provided by the operational abstract machine.

Each operational machine includes a set, O, of operations that animate it. Similarly, each functional system has a set, F, of functionalities that animate it. For each operation, o ∈ O, that the system may perform, there will be a subset, F^{(o)} ⊂ F, of functionalities that will implement it. It is possible, then, to define a relation IMPLEMENTS over O×F such that IMPLEMENTS (o,f) is true if functionality f is used in the implementation of an operation, o. Within each operation, one or more of the system's functionalities will be expressed. For a given operation, o, these expressed functionalities are those with the property F^{(o)}={f: F|IMPLEMENTS(o,f)}.

Each functionality exercises a particular aspect of the functional machine. As long as the system operational profile remains stable, the manner in which the functional machine actually executes is also stable. However, when there is a major shift in the operational profile by the system, then there will be a concomitant shift in the functional profile as well, which redistributes the activity of the functional machine and results in uncharacteristic behavior of the functional machine. This change in the usage of the system constitutes anomalous system activity. It should be noted that this definition of anomalous system activity is much more precise than that used in intrusion detection, i.e., anomaly detection.

Let M be a set of program modules for a system. The software design process is then basically a matter of assigning functionalities f ∈ F to specific program modules m ∈ M. The design process may be thought of as the process of defining a set of relations, ASSIGNS over F×M such that ASSIGNS(f, m) is true if functionality f is expressed in module m.

Each operation in O is distinctly expressed by a set of functionalities. If a particular operation, o, is defined by functionalities fₐ and f_{b}, then the set of program modules that are bound to operation o is M^{(o)}=M^{(f}^{ₐ}⁾ ∪ M^{(f}^{_{b}}⁾, where M^{(f}^{ₐ}⁾ and M(f^{_{b}}⁾ represent the set of program modules associated with functionality fₐ and f_{b}. In general,

$${M}^{( o )} = {⋃}_{IMPLEMENTS ( fi , o )} {M}^{( {f}_{i} )} .$$

### Mappings

There is a distinct mapping from the set of operations to the set of program modules. Each operation is associated with a distinct set of functionalities. These individual functionalities are, in turn, associated with a distinct set of modules. The mappings are explained using an example 150 shown in FIG. 7. In this Figure, there are two operations (o₁ and o₂) in a column 152 that map into a set of four functionalities (f₁ through f₄) in a column 154. These functionalities in column 154 are implemented, in turn, by a total of ten program modules (m₁ through m₁₀) in a column 156. It is clear from this Figure that if the system exercises the operation o₂, then modules m₄, m₆, m₇, m₈, m₉, and m₁₀ will also be invoked.

The modules can be organized into a program call tree as a function of the program design process. The call tree for the above example will look like exemplary tree 160 shown in FIG. 8. In this Figure, it can be seen that an operation 162, identified as o₁, is implemented by a functionality tree comprising functionalities 164, 166, and 168, further identified as f₁, f₂, and f₃. It can also be seen that functionality f₃ is employed in the implementation of both operations o₁ and an operation 170, identified as o₂. Operation o₂ also includes functionality 172, identified as f₄.

TABLE 1

| Word | Prob. | Structure | | | | |
|---|---|---|---|---|---|---|
| w₁ | 0.07 | 1 | 2 | | | |
| w₂ | 0.03 | 1 | 2 | 3 | | |
| w₃ | 0.16 | 1 | 2 | 3 | 5 | |
| w₄ | 0.07 | 1 | 2 | 4 | | |
| w₅ | 0.14 | 1 | 2 | 4 | 6 | |
| w₆ | 0.18 | 1 | 2 | 4 | 7 | |
| w₇ | 0.12 | 1 | 8 | | | |
| w₈ | 0.01 | 1 | 8 | | | |
| w₉ | 0.15 | 1 | 8 | 9 | | |
| w₁₀ | 0.07 | 1 | 8 | 10 | | |
| w₁₁ | 0.00 | 1 | 8 | 10 | 4 | |
| w₁₂ | 0.00 | 1 | 8 | 10 | 4 | 6 |
| w₁₃ | 0.00 | 1 | 8 | 10 | 4 | 7 |

As this hypothetical program executes, it will distribute its activity across the arcs of the call tree. This activity is characterized in terms of execution paths that begin at the root and end at all interior and leaf nodes of the tree. In Table 1, above, the possible execution paths of FIG. 8 are shown in the section of the table labeled “Structure.” Each such path represents a word in the execution vocabulary of the program. For example, the word w₁₁ corresponds to the execution path 1-8-10-4 of the exemplary tree. If the program is allowed to run for a number of execution epochs, the actual distribution of program activity represented by the words in the execution vocabulary is shown in the column labeled “Prob.” (for probability). This probability is the relative likelihood that the word in that row will be expressed in the observed execution epochs of the program. As such, the values in this column also represent the probability that the program will follow a state sequence corresponding to the associated execution path of the call graph.

In this hypothetical execution, interval functionality f₃ was invoked during the execution of operation o₁, but it was not invoked during the execution of operation 02, as is evidenced by the fact that p(w₁₁)=p(w₁₂)=p(w₁₃)=0.0.

Any of the root nodes of the sub-trees of the call tree are potential candidates for threads of execution. Accordingly, it is appropriate to associate execution threads with functionalities.

### Certifying Software Systems

During its development, and particularly, during the test process, a software system will be subjected to a wide range of activity. The upshot of this testing activity is that the software will have been exercised over a subset of its possible operational space. Having tested the software through a set of user operations that induced a set of measurable activity on the software, the developer might then be willing to certify the operation of the software as long as it was used in a manner similar to the way that it was tested. To this end, the mathematical description of nominal activity is referred to herein as a “software certificate.” It will become the set point for the process control system. As long as the software is used in the same manner that it was tested, that is, as long as its use does not depart from the certified activity represented by the software certificate, it is reasonable to expect that it would work reliably or that it is not being compromised.

The greatest threat to the reliable operation of the system is the unanticipated operational demands placed on the system by a changed operational environment, which can happen in one of two distinct ways. From a security perspective, the unanticipated operational demand can occur if a system vulnerability has been exploited. From a reliability perspective, the system may have been driven into an untested and uncertified module domain. As a consequence, the system will shift from a reliable operational profile (i.e., as certified by the software developer), to an uncertified profile. In this event, it will be important to understand whether the new behavior can be tested and possibly certified as reliable. To do so, the software system should be suitably instrumented to provide sufficient information to reconstruct the system activity and validate the correctness of that behavior and the associated system components. The main objective of the dynamic measurement methodology is to capture any activity that is considered uncertified, in real time. It is possible, from the observed activity of the software modules, to determine with a certain level of confidence, the reliability of a system under one or more certified operational profiles.

A key assumption is that uncertified software activity has important consequences. The departure of a software system from its underlying certificate is a likely indication that the software/hardware component has failed, a malicious attack has occurred, or that the user(s) have initiated a sequence of uncertified operations. The failure event itself is made tangible through the execution of uncertified system activity. The monitor engine functions by noting the difference between the current state of the system and a model that represents the normal, or certified, execution environment. Once a determination has been made by the analytical engine as to the specific nature of the departure from the certificate or set point, corrective action may then be initiated by the adaptive engine.

The basic notion of certified software execution is that the certificate specifies the range of acceptable values that the measurement attributes may take while the target software system is executing. When an executing software system is observed to be operating outside the range of the certificate, then the adaptive engine will alter the course of execution of the software process. This alteration may include, for example, the elimination of some of the software functionality, which will in turn, cause the software to constrain its activity to a subset of possible observation values in the controlled variables, or may result in the termination of the software process, or other limitation on its operational scope.

### Within and Between Module Measurement

The attribute space of dynamic software measurement is very large. However, these measurements can be partitioned into measurements that are taken at the module level and above, and those that are taken within each program module. The set of measurements taken at the module level of granularity and above are referred to herein as “Between Module Measurements.” The set of measurements that are taken when a single module is executing are referred to herein as “Within Module Measurements.”

In order to provide a clear explanation, it will be necessary to define the concept of a program module. For the purposes of this discussion and as used herein, a program module is a set of machine instructions that can be accessed through the use of a machine CALL instruction. The set of machine instructions begins with an instruction that is the object (destination) of the CALL instruction. It is delimited by a machine RETURN instruction. In other words, control is passed to a program module by a CALL instruction, and control is relinquished by the module through the use of a RETURN instruction.

### Possible “Between Module Measures”

An executing program may be represented structurally in one of two distinct ways. By design, the modules are linked together into a call graph data structure. In this representation, a node in the graph represents a module. Incoming arcs to this node represent calls to the module, and the outgoing arcs from the node represent calls to other program modules. There are a number of distinct measures that may be developed from this call graphical representation. The major problem with this representation is that a module or a sub-graph representing a functionality may be used in a number of different contexts. It might be perfectly normal for the module (or the root of the sub-graph) to be invoked in one or two different contexts but completely abnormal for it to be invoked in any other context.

An alternate means of representing a program is as a call tree. In this approach, each program module is represented by a node in the call tree. However, the indegree, i.e., the number of entering edges, is restricted to be one. Thus, if a program module is invoked by several different modules, it will be represented by many different nodes in the call tree—one for each module invoking that module.

Beginning with the main program module, the called program module names may be placed on a call stack. Each program module will be a letter in the potential execution alphabet of the program. At any point in the program execution, the instantaneous description of the program call stack contains an ordered set of letters from the program execution alphabet. This set of letters represents a word, wᵢ, from the execution vocabulary, W, of the program. The key to the success of this approach of real time monitoring of an executing process is quite simple. There is a vast disparity between the cardinality of the set, W, i.e., of all possible words in the execution vocabulary and the cardinality of the set of words, W_{C}, that actually occurs in a certified execution context. That is, the number of elements in the set W_{C} is very much smaller than the number of elements in W.

The distribution of words in an execution vocabulary is also directly dependent on the execution context. Let, pᵢ=p(wᵢ) represent the probability of encountering word wₗ ∈ W_{C} during the normal execution of a program. The underlying probability distribution of the pᵢ is a distinct attribute of the program execution in a particular context. The nominal activity, then, of a program in execution is embodied in the set, W_{C} and the probability distribution associated with each of the elements of this set. The key concept, here, is that when the execution framework of a program changes, then the distribution of the pᵢ will also change. It is also possible that a new word, wⱼ, will appear on the call stack, where wⱼ ø W_{C}.

The distribution of the wᵢ is far from uniform. Just as is the case with the English language, some words will occur very frequently, while others may not be expressed at all. This concept is described by the notion of entropy. Accordingly, the entropy, h, of an application in this context is given by h=−Σᵢp(wᵢ)logp(wᵢ). Thus, it is a relatively simple matter to ascertain the underlying distribution of the pᵢ. It is a key feature of most software systems that they are very low entropy applications, which in turn, means that the calibration phase of a typical application is also very short.

If there is a significant change in the entropy of a system due to its usage patterns, when it is placed in service, from that determined during its calibration, then there is a clear indication that the system is being exercised in a very different manner from that for which the calibration was established. There are two possible cases here. Either the entropy will rise above the calibration entropy, or it will be lower. In either event, the change in entropy will reflect the fact that the software is being exercised in a different manner from the calibration activity. System entropy, then, is also a dynamic measure of system activity—and thus, is an indicator of abnormal system activity.

It is also possible to measure the distribution of dwell time for each word in the execution vocabulary. The actual real time (measured in processor cycles) can easily be measured for each instantiation of each word. If the actual execution time associated with a program module when the program is placed in service is at variance with the calibrated execution time, then the program module is likely being exercised in a manner different from its calibration suite of activities.

It is further possible to monitor the flow of data into and out of each program module. From a mathematical perspective, a program module performs a functional transformation on a point, a, in an argument space, to a new point, b, in this space. In this case, a=<a₁, a₂, . . . aₙ>, where aᵢ is the value of the i^{th} argument in a call to a function module and where the dimensionality of the argument space for the program module is given by m. Each of the aᵢ is defined on a finite set of integral values typically represented by a bit string in computer memory.

Following the same logic, b=<b₁, b₂, . . . bₘ>. The set of certified values for a constitutes the range on which a is defined. The set of certified values for b constitutes the domain for b. Thus for the j^{th} program module, this functional transformation can be represented by b=f^{j}(a).

If a function is passed a point in the argument space that is outside the range of certified argument points, then it is possible that the execution of the module/function will produce anomalous results. Similarly, if a function transforms a certified point, a, in the argument space to a new point, e.g., b′, which is not in the certified domain of values, then the function can be said to have produced an anomalous result.

Possible within Module Measures

Perhaps the most significant measures that can be taken on the internal operation of a module relate to the flow of control within the module. The “within module” structure is best explained with a flow graph representation. This flow graph includes a set of nodes and edges. The nodes represent activity events in the program flow, such as processing or decisions, and the edges represent program flow from one node to another.

A control flow graph of a program module is constructed from a directed graph representation of the program module that can be defined as follows:
A directed graph, G=(N, E, s, t), comprises a set of nodes, N, a set of edges E, a distinguished node s, the start node, and a distinguished node t, which is the exit node. An edge is an ordered pair of nodes, (a, b).
An in-degree I(a) of a node a is the number of edges entering a.
An out-degree O(a) of the node a is the number of edges exiting from a.

The flow graph representation of a program, F=(E′, N′, s, t), is a directed graph that satisfies the following properties.
There is a unique start node s such that I(s)=0.
There is a unique exit node t such that O(t)=0.

All other nodes are members of exactly one of the following three categories.
Processing Node: has one entering edge and one exiting edge. They represent processing node a as follows: I(a)=1 and O(a)=1.
Predicate Node: represents a decision point in the program as a result of if statements, case statements, or any other statement that will cause an alteration in the control flow. For a predicate node a, I(a)=1 and O(a)>1.
Receiving Node: represents a point in the program where two or more control flows join, for example, at the end of a while loop. For a receiving node a, I(a)>1 and O(a)=1.

If (a, b) is an edge from node a to node b, then node a is an immediate predecessor of node b, and node b is an immediate successor of node a. The set of all immediate predecessors for node a is denoted as IP(a). The set of all immediate successors for node b is denoted as IS(b). No node may have itself as a successor. That is, a may not be a member of IS(a). In addition, no processing node may have a processing node as a successor node. All successor nodes to a processing node must be either predicate nodes or receiving nodes. Similarly, no processing node may have a processing node as its predecessor.

From this control flow graph representation, two essential control flow primitive metrics emerge:
number of nodes
number of edges

A path P in a flow graph F is a sequence of edges <\vec{a₁a₂},\vec{a₂a₃}, . . . , \vec{a_{N-1}a_{N}}> where all aᵢ (I=1, . . . , N) are elements of N′. P is a path from node a₁ to node aₙ. An execution path in F is any path P from s to t.

Another very important feature of a flow graph, the representation of program iteration constructs, must be considered. A program may contain cycles of nodes created by if statements, while statements, and so forth. These iterative structures are called cycles as opposed to the more familiar concept of a programming loop.

A path through a flow graph is an ordered set of edges (s, . . . , t) that begins on a starting node s and ends on a terminal node t. A path may contain one or more cycles. Each distinct cycle cannot occur more than once in a sequence. That is, the sub-path (a, b, c, a) is a legal sub-path, but the sub-path (a, b, c, a, b, c, a) is not, because the sub-path (a, b, c, a) occurs twice.

The Total Path Set of a node a is the set of all paths (s, a) that goes from the start node to node a itself The Cardinality of the set of paths of node a is equal to the total path count of the node a. Each node singles out a distinct number of paths to the node that begin at the starting node and end with the node itself. The path count of a node is the number of such paths. The module path count is set to the number of total paths from s to t.

Cycles are permitted in paths. For each cyclical structure, exactly two paths are counted: (a) one that includes the code in the cycle; and, (b) one that does not. In this sense, each cycle contributes a minimum of two paths to the total path count.

As each program module is executed, it will excise a subset of the possible paths in the module flow graph. The cardinality of the excised subset is a measure that can be taken on the execution activity. When the software has been calibrated for the purposes of certification, the sub-flow graph representing the totality of module paths from the certification process for that module will constitute the certified sub-flow graph. When the program module is placed into service, it is possible to assert that the path selected by the most recent module execution is a member of a set of certified paths from a certified sub-flow graph. The nature of uncertified departure of the module execution may be measured by the cardinality of new module paths and new nodes that are not in the certified sub-flow graph.

Within the certified sub-flow graph, there is a set of processing nodes A′={a₁,a₂, . . . , aₘ} where A′ ⊂ A and A represent the complete set of processing nodes from the actual module flow graph. It is possible to define a probability distribution pᵢ=Pr(aᵢ), such that pᵢ represent the probability of executing the code in processing node aᵢ under a certified distribution of processing node activity. When the program containing the module is placed into service at some future time, the new observed distribution of processing node activity can be represented by p′ᵢ=fᵢ/F, where fᵢ is the observed frequency of execution of processing node aᵢ, and F represents the cumulative count of the execution of all processing blocks with that module. It is possible to measure the disparity of the current distribution of activity within the module processing blocks with the distance function

$$d = {\sum }_{i = 1}^{n} {( {p}_{i}^{′} - {p}_{i} )}^{2} .$$

The certified processing node set is the set of all processing nodes that will be executed during the certification process. At run time, it is possible to enumerate the number of processing nodes that are executed, which are not members of the certified processing node set.

The arguments passed to each program module when control is passed to it may be represented as a vector of dimensionality n. Each time that a program module is invoked, it will be supplied with a new argument list, again, represented as a vector. Each of these vectors represents a point in an n-dimensional space. During the certification process, the set of all such argument vector points will constitute a cluster of values in the n-dimensional space. This cluster may be represented by a single point, which corresponds to the centroid of the cluster. The centroid may be computed in a number if different ways. Perhaps the most useful of such representations is to define the centroid, c̅, as yet another point in the same n-dimensional argument space, where c̅=< x̅₁, x̅₂, . . . , x̅ₙ>, and x̅ᵢ represents the mean of the observed argument values for the i^{th} argument. Changes in the centroid that are detected when executing the software process relative to the centroid determined during the certification process can thus be an indication of abnormal activity during execution of the software process.

The preceding discussion is not intended to provide an exhaustive list of exemplary “within module” measures. Instead, it simply indicates some of the within module measures that can be employed for monitoring the run time activity within program modules.

### Software Instrumentation

The actual telemetry from an executing software system may be gathered either in software through the use of software probes or it may be gathered directly from the hardware system on which the software is executing. The software being monitored may be modified to incorporate such software probes. Typically, a software probe will include a Call statement inserted into the software at one or more predefined points. When the Call statement is encountered at run time, control is passed by the Call to a monitor routine that records the event.

Experience has shown, however, that the act of monitoring a software system in software involves a substantial amount of computational overhead. In the case of real time embedded systems, this overhead may dramatically affect the ability of the monitored software to respond within critical time frames dictated by the temporal design constraints of the embedded software itself. One value of the exemplary software implementation is that it clearly demonstrates the viability of the modeling effort, even if it may not be as desirable as using hardware for monitoring a software process.

Although the concepts disclosed herein have been described in connection with the preferred form of practicing them and modifications thereto, those of ordinary skill in the art will understand that many other modifications can be made thereto within the scope of the claims that follow. Accordingly, it is not intended that the scope of these concepts in any way be limited by the above description, but instead be determined entirely by reference to the claims that follow.

The invention in which an exclusive right is claimed is defined by the following:

1. A method for automatically monitoring and adaptively controlling a software process executing on a computing device, comprising the steps of:
(a) executing the software process on a computing device so that the software process progresses to a normal termination;
(b) automatically testing the software process while it is executing, to determine and record an activity comprising a set of functions for the software process that are carried out during a normal execution of the software process;
(c) automatically monitoring the software process as it is subsequently executed on a computing device to determine if the activity of the software process as it is being monitored deviates from the activity that was determined and recorded when the software process was being tested, indicating that execution of the software process is abnormal; and if so,
(d) automatically implementing a predefined action; and if not,
(e) permitting the software process to continue executing.

2. The method of claim 1, wherein the step of automatically testing comprises the step of certifying the software process for a defined context, producing an execution certificate that is associated with the software process and is accessed when executing the software process to carry out the step of automatically monitoring.

3. The method of claim 2, wherein a smallest unit of the software process that is scheduled to be executed comprises at least one task, and wherein, as pertinent information representing a switch to a new task is generated, further comprising the step of binding a process controller to the execution certificate representing the new task.

4. The method of claim 1, further comprising the step of expressing the software process as a plurality of program modules structured into call trees based upon calls among the program modules, so that functionalities of the program modules are expressed as sub-trees of the call trees, further comprising the step of using the sub-trees to construct a functionality sub-tree displaying the interrelationship of the set of functions carried out during the normal execution of the software process and revealing an operational structure of the software process.

5. The method of claim 1, wherein the step of automatically monitoring comprises the step of dynamically identifying changes in the activity currently being carried out by the software process that deviate from the activity determined when the software process was being tested and therefore are likely attributable to a failure event or to execution of an attack on the software process.

6. The method of claim 1, wherein the step of automatically implementing the predefined action comprises the step of modifying the executing software process and thus, attempting to correct a deviation in the current activity from the activity that was determined when the software process was being tested.

7. The method of claim 1, wherein the step of automatically implementing the predefined action comprises the step of implementing a policy that specifies when to take the action, and an action that is to be taken.

8. The method of claim 1, wherein for each operation performed in the software process, there is a subset of functionalities that will implement it, and wherein each functionality in the subset is assigned to one or more specific program modules, further comprising the step of mapping the operations that are carried out by the software process during its normal operation to the functionalities that will then be implemented, and each functionality that will be implemented to the one or more specific program modules that will be called to implement the functionality.

9. The method of claim 8, wherein the step of mapping identifies each possible program module execution path, each program module execution path representing a word in an execution vocabulary of the software process, the step of automatically testing comprising the step of determining a probability or relative likelihood of each word being observed during a plurality of normal executions of the software process, thereby defining a probability distribution for the words encountered during the normal execution of the software process.

10. The method of claim 9, further comprising the step of using the probability distribution for the words encountered during normal execution of the software to determine an entropy for the software process, wherein a substantial change in the entropy of the software process when subsequently being automatically monitored indicates that the software process has deviated from the activity measured when the software process was being tested.

11. The method of claim 9, wherein the step of automatically monitoring the software process comprises the step of determining whether an execution time associated with a program module when the software process was automatically tested substantially varies from an execution time when the software process is being monitored, and if so, determining that the program module is likely being exercised in a manner different from that when the software process was being tested.

12. The method of claim 4, wherein for each program module that implements a function, the step of automatically monitoring comprises the step of monitoring a flow of data into and out of the program module to determine whether the function is passed a point in an argument space that is outside a range of certified argument points, or whether the function has transformed a certified point in the argument space to a new point that is not in a certified domain of values, and if so, determining that the function implemented by the program module has produced an anomalous result, so that execution of the software process is abnormal.

13. The method of claim 4, wherein the step of automatically testing comprises the step of determining a flow graph and a probability distribution for paths in a subset of all possible paths through the flow graph for each program module executed by the software process, each flow graph comprising a set of nodes and edges for the program module, and each path comprising an ordered set of edges that begins on a starting node and ends on a terminal node, and wherein the step of automatically monitoring comprises the steps of determining a difference between the probability distribution of the paths actually used for each program module executed during execution of the software process, and based upon any difference identified, determining if the execution of the software process is abnormal.

14. The method of claim 4, wherein each time that a program module is executed that is provided an argument list, the argument list is represented as a vector of points corresponding to a cluster of values in an n-dimensional space, the step of automatically testing comprises the step of determining a centroid for the cluster of values, and wherein the step of automatically monitoring comprises the steps of determining a centroid for a cluster of values comprising an argument list provided to the program module during subsequent execution of the software process, and based upon a difference between the centroid that was determined when the software process was tested and that determined during subsequent execution of the software process, determining that execution of the software process is abnormal.

15. A system for monitoring execution of a software process by a monitored computing device, comprising:
(a) a monitor engine that is coupled to the monitored computing device, the monitor engine including an analytical engine and a certificate data storage in which data comprising certified activities are stored, the analytical engine monitoring a current activity resulting from execution of the software process by the monitored computing device, the analytical engine comparing the current activity with a certified activity accessed in the certificate data storage, wherein the certified activity comprises a set of functions for the software process that were automatically determined during a calibration phase conducted during a normal execution of the software process, the analytical engine comparing the current activity with the certified activity to determine if the software process currently executing on the monitored computing device is behaving abnormally; and
(b) an adaptive engine executed by the monitored computing device and coupled to the analytical engine, the analytical engine causing the adaptive engine to carry out a predefined action if the analytical engine determines that the software process currently executing on the monitored computing device is behaving abnormally.

16. The system of claim 15, wherein during the calibration phase, the analytical engine certifies the software process for a defined context, producing an execution certificate that is associated with the software process and is stored in the certificate data storage, the execution certificate being accessed by the analytical engine when the software process is subsequently executed, to enable the analytical engine to automatically determine whether the current activity has deviated from the certified activity for the software process.

17. The system of claim 15, wherein the analytical engine comprises a process controller, and wherein a smallest unit of the software process that is scheduled to be executed comprises at least one task, so that as pertinent information representing a switch to a new task is generated, the process controller binds to the execution certificate representing the new task.

18. The system of claim 15, wherein the analytical engine expresses the software process as a plurality of program modules structured into call trees based upon calls among the program modules, so that functionalities of the program modules are expressed as sub-trees of the call trees, and uses the sub-trees to construct a functionality sub-tree displaying the interrelationship of the set of functions carried out during the normal execution of the software process so as to reveal an operational structure of the software process used in determining the certified activity of the software process.

19. The system of claim 15, when comparing the current activity to the certified activity, the analytical engine dynamically identifies changes in the activity currently being carried out by the software process that deviate from the certified activity determined when the software process was being tested, since such changes are attributable to a failure event or to execution of an attack on the software process.

20. The system of claim 15, wherein under control of the analytical engine, the adaptive engine modifies the executing software process to attempt to correct a deviation in the current activity from the activity that was determined when the software process was being tested.

21. The system of claim 15, wherein the predefined action that is implemented by the adaptive engine is defined by a policy that specifies when to take the predefined action, and an action to be taken.

22. The system of claim 15, wherein for each operation performed in the software process, there is a subset of functionalities that will implement it, each functionality in the subset being assigned to one or more specific program modules, and wherein to determine the certified activity, the analytical engine maps the operations that are carried out by the software process during its normal operation to the functionalities that will then be implemented, and maps each functionality that will be implemented to the one or more specific program modules that will be called to implement the functionality.

23. The system of claim 22, wherein when mapping, the analytical engine identifies each possible program module execution path, each program module execution path representing a word in an execution vocabulary of the software process, the analytical engine further determining a probability or relative likelihood of each word being observed during a plurality of normal executions of the software process, thereby defining a probability distribution for the words encountered during the normal execution of the software process.

24. The system of claim 23, wherein the analytical engine uses the probability distribution for the words encountered during normal execution of the software to determine an entropy for the software process and if a substantial change in the entropy of the software process is detected when the software process is subsequently being executed, the analytical engine determines that the software process has deviated from the certified activity measured when the software process was tested during the calibration phase.

25. The system of claim 23, wherein the analytical engine determines whether an execution time associated with a program module when the software process was automatically tested during the calibration phase substantially varies from an execution time when the software process is subsequently executed, and if so, the analytical engine determines that the program module is likely being exercised in a manner different from that when the software process was being tested during the calibration phase.

26. The system of claim 23, wherein for each program module that implements a function, the analytical engine monitors a flow of data into and out of the program module to determine whether the function is passed a point in an argument space that is outside a range of certified argument points in accord with the certified activity, or whether the function has transformed a certified point in the argument space to a new point that is not in a certified domain of values in accord with the certified activity, and if so, determines that the function implemented by the program module has produced an anomalous result, so that execution of the software process is abnormal.

27. The system of claim 23, wherein the analytical engine determines a flow graph and a probability distribution for paths in a subset of all possible paths through the flow graph for each program module executed by the software process during the calibration phase, as part of the certified activity, each flow graph comprising a set of nodes and edges for the program module, and each path comprising an ordered set of edges that begins on a starting node and ends on a terminal node, and determines whether a difference exists between the probability distribution of the paths actually used for each program module executed during subsequent execution of the software process, and based upon any difference identified, determines if the execution of the software process is abnormal.

28. The system of claim 23, wherein each time that a program module is executed that is provided an argument list, the argument list is represented as a vector of points corresponding to a cluster of values in an n-dimensional space, the analytical engine determining a centroid for the cluster of values during the calibration phase as part of the certified activity and determining a centroid for a cluster of values comprising an argument list provided to the program module during subsequent execution of the software process, so that based upon any difference between the centroid that was determined when the software process was tested during the calibration phase and the centroid that was determined during subsequent execution of the software process, can be used by the analytical engine for determining that execution of the software process is abnormal.

29. The system of claim 15, wherein the monitor engine comprises a process controller and a task monitor, and wherein the monitored computing device further executes a task messenger, and a policy engine, the task messenger monitoring a task switching function in an operating system of the monitored computing device to track an assignment of software processes to one or more processors in the monitored computing device, the task messenger building a vector identifying the software process and specific processor executing the task at each context switch, the task monitor using the vector to bind the process controller to an execution certificate representing the task, and the policy engine defining a policy that determines when to take the predefined action and what action to take if the analytical engine determines that a task is executing in an aberrant manner.

30. The system of claim 15, wherein the monitored computing device comprises a complex instruction set computer (CISC), and wherein the monitor engine comprises a reduced instruction set computer (RISC) that includes a logic analyzer that monitors an instruction pointer register to detect pointer altering events and to signal the analytical engine with updated address information and an indication of the activity that caused an update of the instruction point register, the CISC being coupled to a decoder that translates bus activity on the CISC in an instruction pipeline for activities that cause a change in the instruction pointer for input to the logic analyzer, wherein changes in the activity being monitored that deviate from the certified activity cause the analyzer engine to detect that the monitored computing device is behaving abnormally.

31. The system of claim 15, wherein the monitor engine comprises a peripheral component interconnect (PCI) express circuit that is coupled to a bus in the monitored computing device, and wherein the software process provides call and return instructions that are detectable at a bus level.
